(19) United States
(12) Patent Application Publication
(10) Pub. No.: US 2006/0274129 A1
(43) Pub. Date: Dec. 7, 2006

(54) Ink supply system for ink cartridge

(76) Inventors: Young-su Lee, Yongin-si (KR); Myung-song Jung, Gunpo-si (KR); Jao-cheol Lee, Hwaseong-si (KR)

Correspondence Address: STANZIONE & KIM, LLP, 919 18TH STREET, N.W., SUITE 440, WASHINGTON, DC, 20006, US

(21) Appl. No.: 11/288,334

(22) Filed: Nov. 29, 2005

(30) Foreign Application Priority Data
Jun. 1, 2005 (KR) 2005-46738

(51) Int. Cl. B41J 2/175

(52) U.S. Cl. 347/85

(57) ABSTRACT

An ink supply system for an ink cartridge includes an ink tank and a negative pressure regulator. The ink tank holds ink of a predetermined color therein and has an exit port disposed on a lower portion thereof to dispense ink from the tank. The negative pressure regulator is attached to the ink tank and has a body, a needle protruding from an upper portion of the body, and a needle protective member disposed about the needle and to move vertically over the needle. When the ink tank and the negative pressure regulator are assembled, the exit port presses down on the needle protective member, and the needle extends from the needle protective member into the exit port.

### CROSS-REFERENCE TO RELATED APPLICATIONS

This application claims the benefit under 35 U.S.C. § 119 of Korean Patent Application No. 2005-46738, filed on Jun. 1, 2005, in the Korean Intellectual Property Office, the disclosure of which is incorporated herein in its entirety by reference.

### BACKGROUND OF THE INVENTION

1. Field of the Invention

The present general inventive concept relates to an ink supply system for an ink cartridge, and more particularly, to an ink supply system for an ink cartridge used in a wide array inkjet printer having a needle protective member on an upper portion of a negative pressure regulator to prevent ink from drying.

2. Description of the Related Art

Wide array inkjet printers, which have print heads as wide as a printer paper, have emerged in the market. Unlike typical inkjet printers having ink cartridges that move laterally back and forth across the width of the printer paper, the wide array inkjet printers perform print operations by feeding the printer paper across a stationary ink cartridge, thereby printing at a faster speed than the typical inkjet printers.

FIG. 1A is an exploded perspective view of a conventional ink supply system for an ink cartridge used in a wide array inkjet printer.

Referring to FIG. 1A, the conventional ink supply system for the ink cartridge includes a cartridge frame 15, an ink tank 13 installed on an upper portion of the cartridge frame 15, and a negative pressure regulator 20 disposed at a lower portion of the cartridge frame 15 and connected to the ink tank 13. The ink tank 13 includes a housing forming an exterior thereof and an ink reservoir disposed inside the housing for holding ink. An ink exit port 14 for transmitting ink outside the ink tank 13 is disposed at a lower portion of the ink tank 13. At a top portion of the cartridge frame 15, a frame pipe 16 is provided for guiding the ink exit port 14 of the ink tank 13. The negative pressure regulator 20 includes a body 21 for regulating negative pressure and a needle 22 disposed above the body. An ink dispensing hole (not shown) connecting the interior of the body 21 to the exterior is defined inside the needle 22. The negative pressure regulator 20 is installed at the lower portion of the cartridge frame 15, and the needle 22 of the negative pressure regulator 20 is disposed in a center region of the frame pipe 16 of the cartridge frame 15, as illustrated in FIG. 1B. The ink tank 13 is assembled to the negative pressure regulator 20 through the frame pipe 16 of the cartridge frame 15, the needle 22 of the negative pressure regulator 20 is inserted into the ink exit port 14 of the ink tank 13, and the ink inside the ink tank 13 flows into the body 21 of the negative pressure regulator 20 through the needle 22. A print head (not shown) is provided at a lower portion of the negative pressure regulator 20 for printing with the ink supplied by the negative pressure regulator 20.

The conventional ink supply system for the ink cartridge has a disadvantage that when the ink tank 13 is detached from the cartridge frame 15, the needle 22 of the negative pressure regulator 20 is exposed to air. The ink in the ink dispensing hole in the needle 22 can dry and clog, causing an interruption in the supply of ink. If the ink supplied by the negative pressure regulator 20 to the print head is insufficient, the print quality deteriorates, and in severe cases, a negative pressure builds up in the ink channel (not shown) between the negative pressure regulator 20 and the print head so that air leaks into the print head rendering the ink cartridge unusable. Also, because the needle 22 protrudes from the negative pressure regulator 20, it poses a hazard of physical harm to a user changing the ink tank 13.

### SUMMARY OF THE INVENTION

The present general inventive concept provides an ink supply system for an ink cartridge having a needle protective member on the upper portion of a negative pressure regulator to prevent ink from drying.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an ink supply system for an ink cartridge, including an ink tank to hold ink of a predetermined color, the ink tank having an ink exit port disposed on a lower portion thereof to dispense ink from the ink tank, and a negative pressure regulator attachable to the ink tank, the negative pressure regulator having a body, a needle protruding from an upper portion of the body, and a needle protective member disposed about the needle to move vertically with respect thereto. When the ink tank and the negative pressure regulator are attached, the exit port of the ink tank presses the needle protective member towards the body of the negative pressure regulator, and the needle extends from the needle protective member into the exit port.

An elastic member may be disposed between the body and the needle protective member to provide an elastic force in an upward direction. A recess of a predetermined depth may be formed on the upper portion of the body around the needle, and a floor of the recess may support the elastic member.

The needle protective member may include a first needle housing having a through-hole formed at its central portion to insert the needle therethrough and a second needle housing to encircle the first needle housing. The first needle housing may be made of rubber or a similarly elastic material.

A guide pipe may be formed on the body to guide the needle protective member in a vertical movement, in which case the guide pipe may be formed to have greater height than a height of the needle.

At least one protrusion may be formed on an outer surface of the needle protective member, in which case a guide slot or a guide groove to guide a movement of the at least one protrusion may be formed on the guide pipe.

The ink tank may be installed on a cartridge frame, and an assembly hole to insert the guide pipe therein may be formed on the cartridge frame.

The foregoing and/or other aspects of the present general inventive concept are also be achieved by providing an ink cartridge comprising an ink supply system for an ink cartridge, the system having an ink tank to hold ink of a predetermined color, the ink tank including an exit port disposed on a lower portion thereof to dispense ink from the ink tank, and a negative pressure regulator attachable to the ink tank, the negative pressure regulator including a body, a needle protruded from an upper portion of the body, and a needle protective member inserted over the needle to move vertically, wherein when the ink tank and the negative pressure regulator are attached, the exit port presses down on the needle protective member, and the needle inserts into the exit port, and a print head to receive ink from the ink supply system to perform printing tasks.

The foregoing and/or other aspects of the present general inventive concept are also be achieved by providing an ink supply system usable in an ink cartridge, the ink supply system comprising an ink reservoir to store ink, and an ink delivery unit connectable to the ink reservoir through a needle pipe surrounded by an ink supply pipe, and the needle pipe having an adjustable needle shield disposed therearound to protect the needle pipe when attaching the ink reservoir to the ink delivery unit.

The foregoing and/or other aspects of the present general inventive concept may also be achieved by providing a printer cartridge comprising an ink supply system having an ink reservoir to store ink and an ink delivery unit removably connected to the ink reservoir through a needle pipe surrounded by a needle shield that is adjustable with respect to the needle pipe to protect the needle pipe when the ink reservoir and the ink delivery unit are removed from each other, and a print head to receive ink from the ink supply system and to dispense the ink stored in the ink reservoir for a printing operation.

The foregoing and/or other aspects of the present general inventive concept are also be achieved by providing a printer cartridge comprising an ink supply system including a plurality of ink storage units to store ink of different colors and a plurality of ink delivery units each removably connected to one of the plurality of ink storage units through an individual needle pipe surrounded by a needle shield that is adjustable with respect to the needle pipe to protect the individual needle pipe, and a print head comprising a plurality of plurality of nozzles formed thereon to dispense the ink of the different colors.

The foregoing and/or other aspects of the present general inventive concept are also be achieved by providing an ink supply system comprising an ink delivery unit to provide ink to a printer head, the ink delivery unit having a body, a needle extending from the body, and a shield disposed around an upper portion of the needle to cover the upper portion of the needle, and an ink storage unit connectable to the ink delivery unit and having an exit port to displace the shield such that the upper portion of the needle is uncovered when the ink storage is connected with the delivery unit.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1A is an exploded perspective view of a conventional ink supply system for an ink cartridge;

FIG. 1B is a perspective view showing a needle disposed inside a frame pipe of a cartridge frame when the negative pressure regulator is assembled with the cartridge frame in the conventional ink supply system of FIG. 1A;

FIG. 2 is an exploded perspective view of a negative pressure regulator of an ink supply system for an ink cartridge according to an embodiment of the present general inventive concept;

FIG. 3 is a cut-away perspective view of the negative pressure regulator of the ink supply system for an ink cartridge of FIG. 2 according to an embodiment of the present general inventive concept;

FIG. 4 is a sectional view of a needle and a needle protective member in the negative pressure regulator of FIG. 3 according to an embodiment of the present general inventive concept;

FIG. 5 is a cut-away perspective view of a cartridge frame of an ink supply system for an ink cartridge according to an embodiment of the present general inventive concept;

FIG. 6 is a cut-away perspective view of the cartridge frame of FIG. 5 with a guide pipe of a negative pressure regulator inserted in an assembly hole thereof according to an embodiment of the present general inventive concept;

FIG. 7 is a perspective view of an ink tank of an ink supply system for an ink cartridge according to an embodiment of the present general inventive concept; and

FIGS. 8A and 8B are sectional views showing an ink tank before and after being assembled to a negative pressure regulator of an ink supply system for an ink cartridge according to an embodiment of the present general inventive concept.

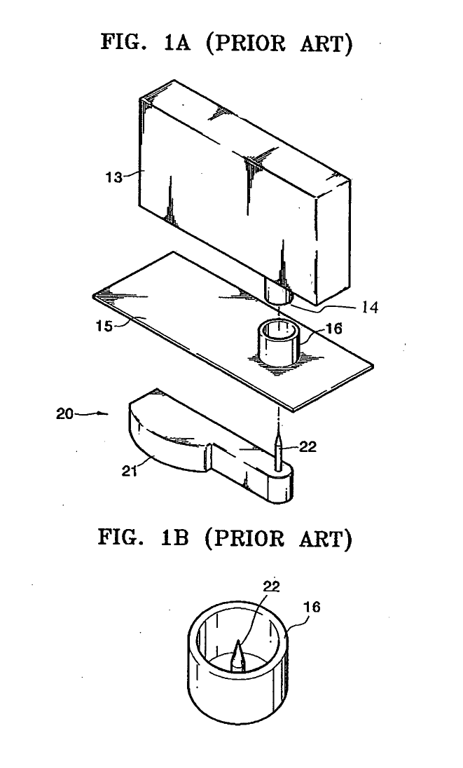

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An ink supply system for an ink cartridge according to an embodiment of the present general inventive concept includes an ink tank to hold ink of a predetermined color, a cartridge frame on which the ink tank is installed, and a negative pressure regulator connected to the ink tank through the cartridge frame. Here, a single ink tank to hold ink of a single color (e.g. black (K)), or a plurality of ink tanks to hold ink of multiple colors (e.g. blue (B), magenta (M), cyan (C), and black (K)) may be provided in the ink supply system for an ink cartridge. When using the plurality of ink tanks, a negative pressure regulator is provided for each individual ink tank.

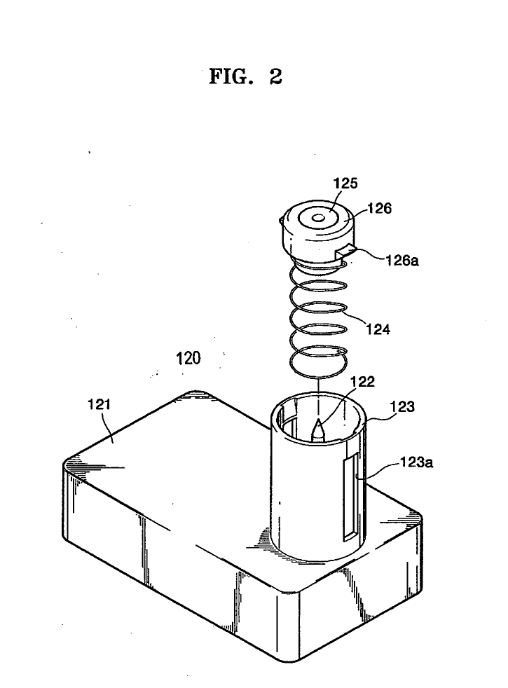

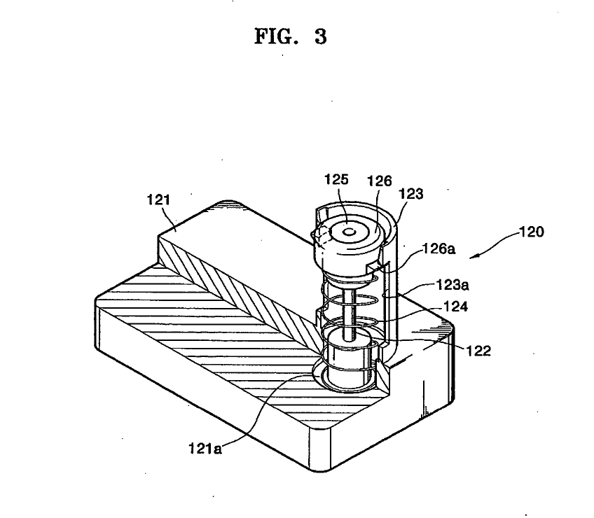

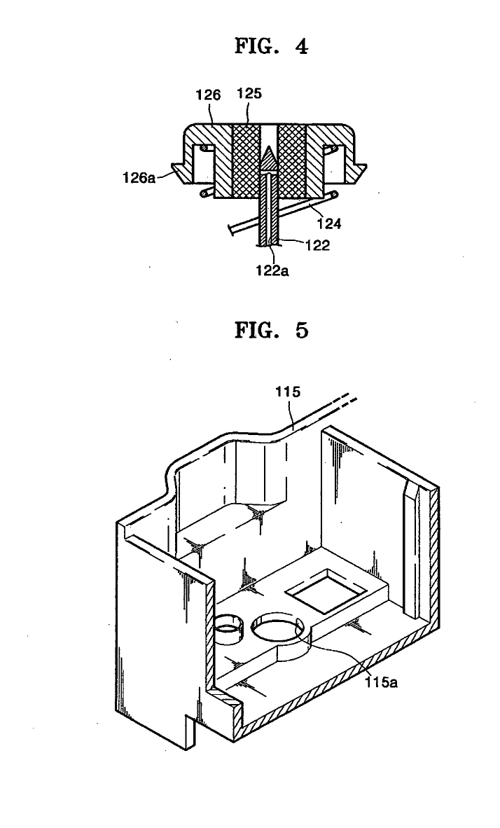

FIGS. 2 and 3 are an exploded perspective view and a cut-away perspective view of a negative pressure regulator of an ink supply system for an ink cartridge according to an embodiment of the present general inventive concept. FIG. 4 is a sectional view of a needle and a needle protective member of the negative pressure regulator illustrated in FIG. 3. In the following description, a direction from a body 121 to the ink tank is referred to as upward and the opposite direction is referred to as downward, for illustration purposes. However, a cartridge position is not intended to be limited by this description and the cartridge may be placed in other orientations.

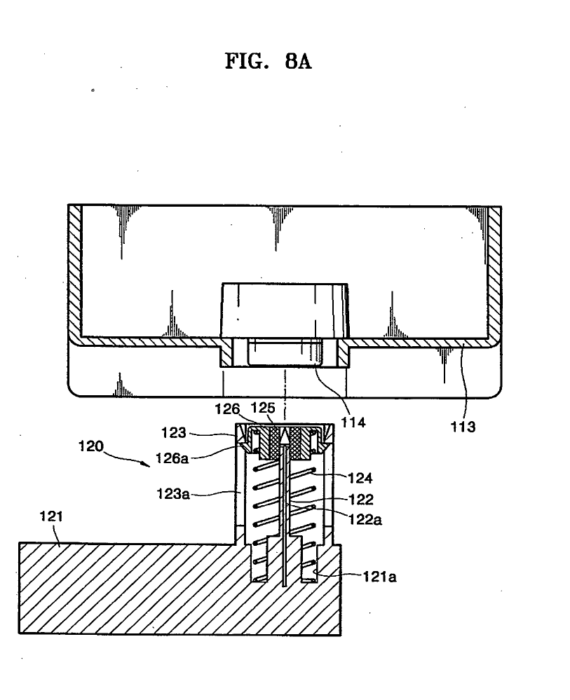

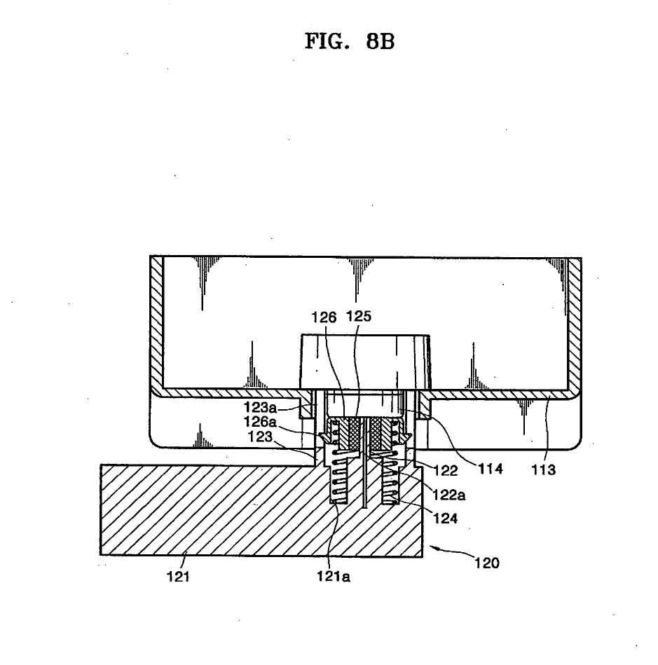

Referring to FIGS. 2 through 4, the negative pressure regulator 120 includes a body 121 to control a pressure therein with a negative pressure, a needle 122 of a predetermined height formed to protrude from the upper portion of the body 121, and a needle protective member to protect the needle 122. The needle 122 connects an exit port 114 (see FIG. 7) of an ink tank 113 (see FIG. 7) to an inside of the body 121 to enable an ink flow. The needle 122 has an ink dispensing hole 122a extending from an upper outer surface of the needle 122 downward through an interior of the needle 122, as illustrated in FIGS. 4, 8A and 8B.

The needle protective member has a first needle housing 125 to insert the needle 122 therethrough, and a second needle housing 126 to surround the first needle housing 125. A through hole to insert the needle 122 therethrough is formed at a center of the first needle housing 125. The first needle housing 125 may be formed of rubber or other elastic material so that the first needle housing 125 contacts the needle 122 with a predetermined elastic pressure. The second needle housing 126 surrounds the first needle housing 125 and may be formed in a molding process. At least one protrusion 126a is formed on the outer surface of the second needle housing 126. Although the present embodiment describes that the needle protective member includes the first and second needle housings 125 and 126 being made of different materials, the needle protective member can also be formed as a single piece with a through hole formed in its center. In this case, the needle protective member can be formed of an elastic material.

An elastic member 124 to exert an upward elastic force to the needle protective member is installed between the needle protective member and the body 121. Here, the elastic member 124 may be a coil spring installed to encircle the needle 122. The elastic member 124 is not limited to the coil spring as in the present embodiment, but may be one of a variety of elastic members installed between the needle protective member and the body 121. Furthermore, a recess 121a of a predetermined depth is formed in the body 121 around the needle 122 in an upper portion thereof, and a floor of the recess 121a supports a lower portion of the elastic member 124 (see FIG. 3). In this case, if ink leaks from the ink exit port 114 of the ink tank 113 (see FIG. 7), the recess 121a can hold the leaked ink, thus preventing the ink from leaking to the outside of either the ink tank 113 or the negative pressure regulator 120. In addition, due to the recess 121a supporting the lower portion of the elastic member 124, a height of the needle 122 (and that of the entire ink supply system) can be reduced.

A guide pipe 123 to guide a vertical movement of the needle protective member is formed to encircle the needle protective member on the upper portion of the body 121. Here, the guide pipe 123 may be formed to have a height that is greater than the height of the needle 122. At least one guide slot 123a is formed through the guide pipe 123 to guide the vertical movement of the at least one protrusion 126a formed on the outer surface of the second needle housing 126. Instead of the at least one guide slot 123a, at least one guide groove (not shown) to guide the vertical movement of the at least one protrusion 126a may be formed on the inner wall of the guide pipe 123. Each of the at least one guide slot 123a or the at least one guide groove corresponds to each of the at least one protrusion 126a on the outer surface of the second needle housing 126. For convenience, hereinafter the description refers to the protrusion 126a and the guide slot 123a, but it should be understood that the protrusion 126a may include a plurality of protrusions and the guide slot 123a may include a plurality of guide slots.

Before the negative pressure regulator 120 is attached to the ink tank 113 (see FIG. 7), the protrusion 126a of the second needle housing 126 is inserted at an upper end of the guide slot 123a of the guide pipe 123 using the elastic member 124 installed between the needle protective member and the body 121. Initially, the first needle housing 125 made of an elastic material blocks the ink dispensing hole 122a on an upper portion at a side of the needle 122, as illustrated in FIG. 4.

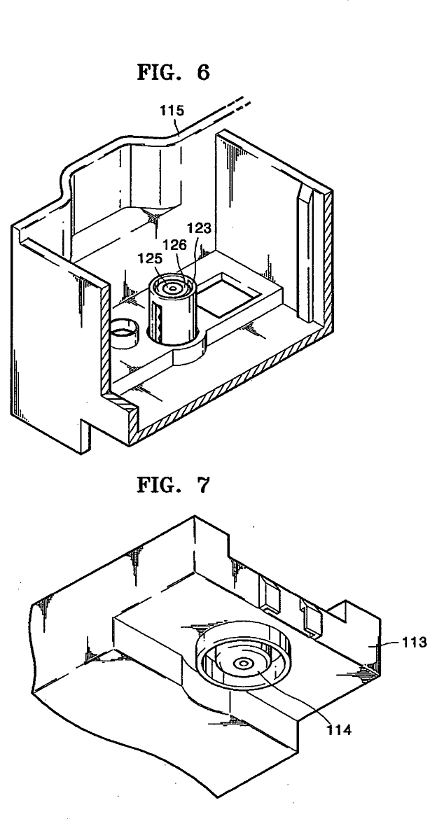

FIG. 5 illustrates a portion of a cartridge frame 115 in which the ink tank 113 (see FIGS. 7, 8A and 8B) is installed. Referring to FIG. 5, an assembly hole 115a is formed through the cartridge frame 115 to enable assembly of the ink tank 113 with the negative pressure regulator 120. FIG. 6 is a cut-away perspective view of the cartridge frame 115 of FIG. 5 with the guide pipe 123 of the negative pressure regulator 120 inserted in the assembly hole 115a thereof, and FIG. 7 illustrates the ink tank 113 to hold ink of a predetermined color. Referring to FIG. 7, the exit port 114 is provided to supply ink stored in the ink tank 113 to the outside through a lower portion of the ink tank 113.

The assembly of the negative pressure regulator 120 and the ink tank 113 of the ink supply system for an ink cartridge is described below with reference to FIGS. 8A and 8B. For convenience purposes, the cartridge frame 115 is not illustrated in FIGS. 8A and 8B.

FIG. 8A illustrates the negative pressure regulator 120 and the ink tank 113 before being connected. Referring to FIG. 8A, the first and second needle housings 125 and 126 are disposed at the top of the needle 122 and pushed upward by the elastic force of the elastic member 124. Here, the protrusion 126a formed on the outer surface of the second needle housing 126 is inserted at the upper end of the guide slot 123a of the guide pipe 123. In this state, a portion of the ink dispensing hole 122a formed on the upper portion of the needle 122 is sealed because it is covered by the first needle housing 125 made of elastic material.

FIG. 8B illustrates the negative pressure regulator 120 assembled with the ink tank 113. Referring to FIG. 8B, when the ink tank 113 and the negative pressure regulator 120 are assembled and the ink exit port 114 of the ink tank 113 presses the first and second needle housings 125 and 126 of the negative pressure regulator 120, the first and second needle housings 125 and 126 are forced down inside the guide pipe 123, whereupon the needle 122 extends out of the first and the second needle housing 125 and 126 and extends into the ink exit port 114 and into the tank 113. Here, the ink in the ink tank 113 flows into the ink dispensing hole 122a of the needle 122 to the inside of the body 21 of the negative pressure regulator 120 to control ink pressure.

Due to the needle protective member, the ink supply system can prevent the ink dispensing hole 122a of the needle 122 from being exposed to air, and therefore drying and clogging when the ink tank 113 is removed from the negative pressure regulator 120 to replace the ink tank 113.

A print head (not shown), which receives ink from the negative pressure regulator 120 and performs printing tasks, is disposed on a lower portion of the ink supply system for the ink cartridge. The print head has a plurality of nozzles formed thereon to dispense ink. The print head forms an ink cartridge together with the above-described ink supply system.

The ink supply system according to various embodiments of the present general inventive concept can be used in an ink cartridge of a wide array inkjet printer. However, the present general inventive concept is not limited to cartridges for the wide array inkjet printer, and the present general inventive concept is equally applicable to ink cartridges of inkjet printers having printer heads that move laterally across a width of a printing page.

According to embodiments of the present general inventive concept, when detaching an ink tank from a negative pressure regulator, an ink dispensing hole of a needle is not exposed to air a movable needle protective member is used, and ink does not dry and cause clogging of the ink dispensing hole. Accordingly, when the ink tank is reconnected to the negative pressure regulator, ink is evenly supplied from the ink tank to a body of the negative pressure regulator. Since a guide pipe to guide a movement of the needle protective member may be formed in one piece with the body, a number of components required to manufacture an ink cartridge decreases, thereby reducing material and manufacturing costs. A recess of a predetermined depth is formed around the needle, and a floor thereof supports a lower portion of an elastic member, thereby minimizing a height of the needle and reducing a height of the ink supply system, as a whole. Also, because the recess holds ink that leaks from an exit port of the ink tank, ink can be prevented from leaking to the outside.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink supply system for an ink cartridge, the system comprising:
an ink tank to hold ink of a predetermined color, the ink tank including an exit port disposed on a lower portion thereof to dispense ink from the ink tank; and
a negative pressure regulator attachable to the ink tank, the negative pressure regulator including a body, a needle protruding from an upper portion of the body, and a needle protective member disposed about the needle to move vertically with respect thereto, wherein when the ink tank and the negative pressure regulator are attached, the exit port presses down on the needle protective member, and the needle extends from the needle protective member into the exit port.

2. The ink supply system of claim 1, further comprising:
an elastic member disposed between the body and the needle protective member to provide the needle protective member with an elastic force in an upward direction.

3. The ink supply system of claim 2, wherein the body comprises:
a recess of a predetermined depth formed on an upper portion thereof around the needle, and the recess having a floor to support a lower portion of the elastic member.

4. The ink supply system of claim 2, wherein the elastic member comprises a coil spring installed to surround the needle.

5. The ink supply system of claim 2, wherein the needle comprises an ink dispensing hole formed on an upper portion surface of the needle and extending through an interior of the needle.

6. The ink supply system of claim 2, wherein the needle protective member comprises:
a first needle housing having a through-hole formed at a central portion of thereof to insert the needle therethrough; and
a second needle housing to encircle the first needle housing.

7. The ink supply system of claim 6, wherein the first needle housing is made of an elastic material.

8. The ink supply system of claim 7, wherein the first needle housing is made of rubber.

9. The ink supply system of claim 2, wherein the needle protective member is made of an elastic material and has a through-hole formed at a central portion thereof to insert the needle therethrough.

10. The ink supply system of claim 2, wherein the body comprises:
a guide pipe formed thereon to guide the needle protective member in a vertical movement.

11. The ink supply system of claim 10, wherein the guide pipe is formed to have a height greater than a height of the needle.

12. The ink supply system of claim 10, wherein the needle protective member has at least one protrusion formed on an outer surface thereof.

13. The ink supply system of claim 12, wherein the guide pipe has a guide slot formed therethrough to guide a vertical movement of the at least one protrusion.

14. The ink supply system of claim 12, wherein the guide pipe has a guide groove formed on an inner wall thereof to guide a vertical movement of the at least one protrusion.

15. The ink supply system of claim 10, wherein the ink tank is installed on a cartridge frame, and the cartridge frame comprises:
an assembly hole formed thereon to insert the guide pipe therein.

16. An ink cartridge comprising:
an ink supply system for an ink cartridge, the system including:
an ink tank to hold ink of a predetermined color, the ink tank having an exit port disposed on a lower portion thereof to dispense ink from the ink tank, and
a negative pressure regulator attachable to the ink tank, the negative pressure regulator including a body, a needle protruding from an upper portion of the body, and a needle protective member to protect the needle and to move vertically with respect thereto, wherein when the ink tank and the negative pressure regulator are attached, the exit port presses down on the needle protective member, and the needle extends from the needle protective member into the exit port; and
a print head to receive ink from the ink supply system to perform printing tasks.

17. The ink cartridge of claim 16, further comprising:
an elastic member disposed between the body and the needle protective member to provide the needle protective member with an elastic force towards the ink tank.

18. The ink cartridge of claim 17, wherein the body comprises:
a recess of a predetermined depth formed on an upper portion thereof around the needle, and the recess having a floor to support a lower portion of the elastic member.

19. The ink cartridge of claim 17, wherein the body comprises:
a guide pipe formed thereon to guide the needle protective member in a vertical movement.

20. An ink supply system usable in an ink cartridge, the ink supply system comprising:
an ink reservoir to store ink; and
an ink delivery unit connectable to the ink reservoir through a needle pipe surrounded by an ink supply pipe and having an adjustable needle shield disposed around the needle pipe to protect the needle pipe when attaching/removing the ink reservoir to/from the ink delivery unit.

21. The ink supply system of claim 20, wherein the ink delivery unit connects to the ink reservoir by changing from a first state of the ink delivery unit, in which the ink reservoir and the ink delivery unit are separate and the needle pipe is covered by the adjustable needle shield, into a second state of the ink delivery unit, in which the needle pipe extends from the needle shield to be inserted into an exit port of the ink reservoir.

22. The ink supply system of claim 21, wherein in the first state a height of the adjustable needle shield covering the needle pipe is substantially equal to a height of the ink supply pipe, and in the second state the height of the adjustable needle shield is less than the height of the ink supply pipe, the adjustable needle shield being pushed down by the exit port of the ink reservoir in the second state.

23. The ink supply system of claim 22, wherein the ink delivery unit comprises a guiding system to prevent the adjustable needle shield from rotating relative to the ink supply pipe when the adjustable needle shield is pushed down by the exit port of the ink reservoir.

24. The ink supply system of claim 23, wherein the guiding system comprises at least one protrusion on the adjustable needle shield and one of a guide slot and a guide groove corresponding to each protrusion formed on the ink supply pipe.

25. The ink supply system of claim 22, wherein the ink delivery unit comprises a recovery mechanism to restore the first state of the ink delivery unit when the ink reservoir is removed from the ink delivery unit.

26. The ink supply system of claim 25, wherein the recovery mechanism exerts an elastic force upwards on the adjustable needle shield.

27. The ink supply system of claim 25, wherein the recovery mechanism comprises a spring surrounding the needle pipe and supported by a recess on a body of the ink delivery unit at the bottom of the needle pipe.

28. The ink supply system of claim 20, wherein the adjustable needle shield comprises one or more layers and at least one layer being in contact with the needle pipe is made of an elastic material.

29. The ink supply system of claim 20, further comprising:
a cartridge frame to support and protect the ink reservoir having an assembly hole to enable connecting the ink reservoir to the ink delivery unit.

30. A printer cartridge, comprising:
an ink supply system having an ink reservoir to store ink and an ink delivery unit removably connected to the ink reservoir through a needle pipe surrounded by a needle shield that is adjustable with respect to the needle pipe to protect the needle pipe when the ink reservoir and the ink delivery unit are removed from each other; and
a print head to receive ink from the ink supply system and to dispense the ink for a printing operation.

31. A printer cartridge, comprising:
an ink supply system including a plurality of ink storage units to store ink of different colors and a plurality of ink delivery units each removably connected to one of the plurality of ink storage units through an individual needle pipe surrounded by a needle shield that is adjustable with respect to the needle pipe to protect the individual needle pipe; and
a print head comprising a plurality of plurality of nozzles formed thereon to dispense the ink of the ink of different colors.

32. An ink supply system, comprising:
an ink delivery unit to provide ink to a printer head, the ink delivery unit having a body, a needle extending from the body, and a shield disposed around an upper portion of the needle to cover the upper portion of the needle; and
an ink storage unit connectable to the ink delivery unit and having an exit port to displace the shield such that the upper portion of the needle is uncovered when the ink storage is connected with the delivery unit.
